(19) United States
(12) Patent Application Publication
(10) Pub. No.: US 2004/0062238 A1
(43) Pub. Date: Apr. 1, 2004

(54) Network switching device

(76) Inventors: Hiroshi Yoshizawa, Chiba (JP); Yoshihiro Ishida, Chiba (JP)

Correspondence Address: Oliff & Berridge, PO Box 19928, Alexandria, VA, 22320, US

(21) Appl. No.: 10/466,073

(22) PCT Filed: Feb. 13, 2002
(86) PCT No.: PCT/JP02/01189

(30) Foreign Application Priority Data
Feb. 14, 2001 (JP) 2001-036688

(51) Int. Cl. H04Q 11/00

(52) U.S. Cl. 370/360

(57) ABSTRACT

Disclosed is a network switching device in which a new connection request packet is held in chronological sequence in a priority-assignment circuit provided corresponding to a priority level contained in the connection request packet, and in a case where the new connection request packet does not exist, the connection request packets being held in the priority-assignment circuits on the lower-priority side are shifted in sequence toward the priority-assignment circuits on the higher-priority side, to be held there.

### TECHNICAL FIELD

The present invention relates to a network switching device provided with multiple ports, which controls a connection between a source port and a destination port to enable simultaneous packet transmission among the multiple ports, and relates more particularly to a priority decision circuit used in the same.

### BACKGROUND ART

As shown in FIG. 5, in a network switching device 50, ports are connected to each other by means of port controllers 52(1, 2 . . . , 10, 11 . . . ) which are connected to each network and a switching fabric 54 which is arranged centrally, to carry out exchange of packets from each port. Representative methods of realizing this switching fabric include a shared bus method and a crosspoint switch method.

The shared bus method as shown in FIG. 6, which shares a bus with a high speed bandwidth to perform packet switching by time division, cannot simultaneously perform data transmissions among the ports with identical timing, as shown in FIG. 7. For example, it cannot perform a transmission from a port 10 to a port 11 while transmitting from a port 1 to a port 2. Therefore, the switching capacity of the switching fabric according to this method is only equal or inferior to the transmission capacity of a shared bus.

In contrast, as shown in FIG. 8, in the case where a crosspoint switching matrix is used, switches formed of built-in transistor are controlled so as to simultaneously establish connections among a plurality of ports. Therefore, assuming that path of each crosspoint switch has, for example, transmission capacity of 1 Gbps (gigabits/second), a switching fabric with a maximum of 5 Gbps can be configured in the case shown in FIG. 8.

Here, a switching sequence of the network switching device using the crosspoint switch method will be explained with reference to FIG. 9.

In the case where the switching control of the packets is to be performed by means of the network switching device employing the crosspoint switch method, first the port controllers for sending and receiving packets send connection request packets to a crosspoint switch controller, as shown in FIG. 9A.

As shown in FIG. 9B, the crosspoint switch controller arbitrates the connection requests sent from the port controllers, establishes a connection, and then returns packets of a connection-establishment responses to the source port controller. The establishment of the connection means to create a transmission path between the source port and the destination port by setting of an internal path in the crosspoint switching matrix as shown in FIG. 8.

Then, as shown in FIG. 9C, the port controller having received the connection-establishment response sends data packets to the destination port via the crosspoint switch, and the switching process ends.

Incidentally, when the switching device using the crosspoint switch method arbitrates the connection requests from each of the port controllers during the process of the above-mentioned packet switching control, if the connection request packets sent from each port controller include priority levels (priorities), the crosspoint switch controller must arbitrates the connection requests according to their priority levels, and also according to chronological order.

FIG. 10 is a conceptual diagram of an example of the connection request packet.

FIG. 10 shows the connection request packet sent to the crosspoint switch controller from the port controller in the switching process shown in FIG. 9. As shown in FIG. 10, the connection request packet contains header information, including a port number of the destination to which the connection must be established, the priority level of the packet and a packet ID (identifier) for identifying the packet.

As shown in FIG. 11, for example, in a case where requests for transmission to a port 4 are generated nearly simultaneously from ports 1, 2 and 3, the crosspoint switch controller must first establish the connection for the port from which a packet with the highest priority level will be transmitted. For example, if connection request packet from the port 1 has the highest priority level, the connection between the port 1 and the port 4 must be established with higher priority than the ports 2 or 3.

### DISCLOSURE OF THE INVENTION

An object of the present invention is to solve the problems in the prior art described above, and to provide a network switching device capable of efficiently performing arbitration of connection requests according to priority levels contained in connection request packets.

In order to achieve the above-mentioned object, according to the present invention, there is provided a network switching device having a plurality of ports, for performing switching control between source ports and destination ports to transmit packets among the plurality of the ports, comprising:

a plurality of port controllers provided in one to one corresponding to each of the ports; a switching fabric for connecting the source ports and the destination ports; and a switching fabric controller for controlling the plurality of the port controllers and the switching fabric according to priority levels assigned to the packets to be transmitted,

wherein, the switching fabric controller comprises a priority decision circuit for holding connection request packets sent from each of the port controllers and deciding the priorities of the connection request packets according to the priority levels contained in the connection request packets; and a control portion for controlling the switching fabric according to the priority level of the connection request packet.

Here, it is preferable that the priority decision circuit comprises a plurality of priority-decision cue buffers provided in one to one corresponding to each of the ports for deciding the priority of the connection request packet to be transmitted to each corresponding port according to the priority level of the connection request packet,

each of the priority-decision cue buffers comprises a plurality of priority-assignment circuits provided corresponding to each of the priority levels in the connection request packet for holding the connection request packet in chronological sequence according to the priority level in the connection request packet; and a write selector for performing control such that a new connection request packet sent from the port controllers is sent to the priority-assignment circuit corresponding to the priority level in the new connection request packet, and

the new connection request packet is held in chronological sequence in the priority-assignment circuit corresponding to the priority level in the new connection request packet, and in a case where the new connection request packet does not exist, the connection request packets being held in the priority-assignment circuits on the lower-priority side are shifted in sequence toward the priority-assignment circuits on the higher-priority side, to be held there.

Also, it is preferable the priority-assignment circuit comprises:

a selector for selectively outputting the new connection request packet, or a lower priority level connection request packet being held in the priority-assignment circuit on the lower-priority side;

a FIFO buffer having buffer cells equal to or more than ports in number, for holding, in chronological sequence, the connection request packets sent from the selector;

a wait counter for counting the number of the connection request packets read out from the FIFO buffer, or for counting time, and for outputting a trigger signal when a counted value reaches a predetermined value; and

a FIFO control circuit for controlling writing of the connection request packet into the FIFO buffer and reading of the connection request packet from the FIFO buffer.

Also, it is preferable that the FIFO buffer outputs a full signal indicating that the connection request packets have been held into all the buffer cells in the FIFO buffer and that a subsequent packet cannot be written thereinto, and an empty signal indicating that no packets are being held in the FIFO buffer, and these signals are sent to the FIFO control circuit, and moreover the full signal is outputted also as status information for error processing.

Also, it is preferable that when the FIFO control circuit receives the trigger signal from the wait counter, the FIFO control circuit operates such that the lower priority level connection request packet sent from the priority-assignment circuit on the lower priority level side is held into the FIFO buffer with top priority, even in the case where there is the new connection request packet.

Also, it is preferable that the switching fabric controller further comprises a plurality of input cue buffers provided in one to one corresponding to each of the port controllers, for holding the packet inputted from each corresponding port.

Also, in the above-described network switching device, it is preferable that each of the port controllers and each of the corresponding input cue buffers are connected to each other in a one to one manner by separate individual paths, and all the input cue buffers and all the priority-decision cue buffers in the priority decision circuit are mutually connected via a first shared bus, and

the network switching device further comprises an input arbitration circuit for determining which input cue buffer from among the plurality of the input cue buffers uses the first shared bus.

Also, it is preferable the switching fabric controller further comprises a plurality of output cue buffers provided in one to one corresponding to each of the port controllers, for holding the packet outputted to each corresponding port.

Also, in the above-described network switching device, it is preferable that each of the port controllers and each of the corresponding output cue buffers are connected to each other in a one to one manner by separate individual paths, and all the output cue buffers and all the priority-decision cue buffers in the priority decision circuit are mutually connected via a second shared bus, and

the network switching device further comprises an output arbitration circuit for determining which output cue buffer from among the plurality of the output cue buffers uses the second shared bus.

Also, it is preferable that there is formed a bypass route directly connecting the first shared bus and the second shared bus.

Also, it is preferable that the switching fabric is a crosspoint switching matrix.

Also, according to the present invention, there is provided a priority-assignment circuit which, when switching control between source ports and destination ports is performed to transmit packets among a plurality of ports, holds, in chronological sequence, connection request packets sent from the plurality of the ports according to priority levels assigned to the connection request packets, comprising:

a selector for selectively outputting a new connection request packet sent from each of the ports, or a lower priority level connection request packet being held in the priority-assignment circuit on the lower-priority side;

a FIFO buffer having a plurality of buffer cells, for holding, in chronological sequence, the connection request packets sent from the selector;

a wait counter for counting the number of the connection request packets read out from the FIFO buffer, or for counting time, and for outputting a trigger signal when a counted value reaches a predetermined value; and

a FIFO control circuit for controlling writing of the connection request packet into the FIFO buffer and reading of the connection request packet from the FIFO buffer.

Here, it is preferable that the FIFO buffer outputs a full signal indicating that the connection request packets have been held into all the buffer cells in the FIFO buffer and that a subsequent packet cannot be written thereinto, and an empty signal indicating that no packets are being held in the FIFO buffer, and these signals are sent to the FIFO control circuit, and moreover the full signal is outputted also as status information for error processing.

Also, it is preferable that when the FIFO control circuit receives the trigger signal from the wait counter, the FIFO control circuit operates such that the lower priority level connection request packet sent from the priority-assignment circuit on the lower priority level side is held into the FIFO buffer with top priority, even in the case where there is the new connection request packet.

Also, according to the present invention, there is provided a priority-decision cue buffer which, when switching control between source ports and destination ports is performed to transmit packets among a plurality of ports, decides priorities of connection request packets to be sent to each destination port according to priority levels in the connection request packets sent from the plurality of the ports, comprising:

a plurality of the priority-assignment circuits according to any one of the above-described aspects provided corresponding to each of the priority levels in the connection request packets; and a write selector for performing control such that a new connection request packet sent from each of the ports is sent to the priority-assignment circuit of the corresponding priority level,

wherein, the new connection request packet is held in chronological sequence into the priority-assignment circuit corresponding to the priority level in the new connection request packet, and in a case where no new connection request packet exists, the connection request packets being held in the priority-assignment circuits on the lower-priority side are shifted in sequence toward the priority-assignment circuits on the higher-priority side, to be held there.

Also, according to the present invention, there is provided a priority decision circuit which, when switching control between source ports and destination ports is performed to transmit packets among a plurality of ports, holds connection request packets sent from the plurality of the ports and decides priorities of the connection request packets according to the priority levels in the connection request packets, and

the priority decision circuit comprises a plurality of the above-described priority-decision cue buffers.

Also, according to the present invention, there is provided a switching fabric controller which, when switching control between source ports and destination ports is performed to transmit packets among a plurality of ports, controls a switching fabric for connecting the source ports with the destination ports, comprising:

the above-described priority decision circuit; and a control portion for controlling the switching fabric according to the priority levels in the connection request packets.

Here, it is preferable that the above-described switching fabric controller further comprises a plurality of input cue buffers provided in one to one corresponding to each of the port controllers that are provided in one to one corresponding to each of the ports, for holding the packet inputted from each corresponding port.

Also, in the above-described switching fabric controller, it is preferable that each of the port controllers and each of the corresponding input cue buffers are connected to each other in a one to one manner by separate individual paths, and all the input cue buffers and all the priority-decision cue buffers in the priority decision circuit are mutually connected via a first shared bus, and

the switching fabric controller comprises an input arbitration circuit for determining which input cue buffer from among the plurality of the input cue buffers uses the first shared bus.

Also, it is preferable that the switching fabric controller according to any one of the above-described aspects further comprises a plurality of output cue buffers provided in one to one corresponding to each of the port controllers and holding packet outputted to the each corresponding port.

Also, in the above-described switching fabric controller, it is preferable that each of the port controllers and each of the corresponding output cue buffers are connected to each other in a one to one manner, by separate individual paths, and all the output cue buffers and all the priority-decision cue buffers in the priority decision circuit are mutually connected via a second shared bus, and

the switching fabric controller comprises an output arbitration circuit for determining which output cue buffer from among the plurality of the output cue buffers uses the second shared bus.

Also, it is preferable that there is formed a bypass route directly connecting the first shared bus and the second shared bus.

### BRIEF DESCRIPTION OF THE DRAWINGS

FIG. 1 is a block diagram outlining an embodiment of a network switching device according to the present invention;

FIGS. 2 is a diagram outlining a configuration of an embodiment of a priority-decision cue buffer according to the present invention;

FIG. 3A and FIG. 3B are conceptual diagrams of an embodiment according to the present invention, representing operations when a connection request packet is held into FIFO buffers;

FIG. 4 is a diagram illustrating a transition of states in an embodiment according to the present invention, representing operations when the connection request packet is held into FIFO buffers;

FIG. 5 is a diagram outlining the configuration of an example of a network switching device;

FIG. 6 is a conceptual diagram of an example for explaining operations of a network switching device using a shared bus method;

FIG. 7 is a conceptual diagram of an example for explaining usage conditions of a bus in the network switching device using the shared bus method;

FIG. 8 is a circuit diagram of an example of a crosspoint switching matrix;

FIG. 9A, FIG. 9B and FIG. 9C are conceptual diagrams of an example representing a packet switching process;

FIG. 10 is a conceptual diagram of an example of the connection request packet; and

FIG. 11 is a conceptual diagram of an example of establishing a connection between ports according to priority levels in the connection request packet.

### BEST MODE FOR CARRYING OUT THE INVENTION

Hereinafter, detailed explanation is made regarding a network switching device according to the present invention based on a preferable embodiment illustrated in the attached drawings.

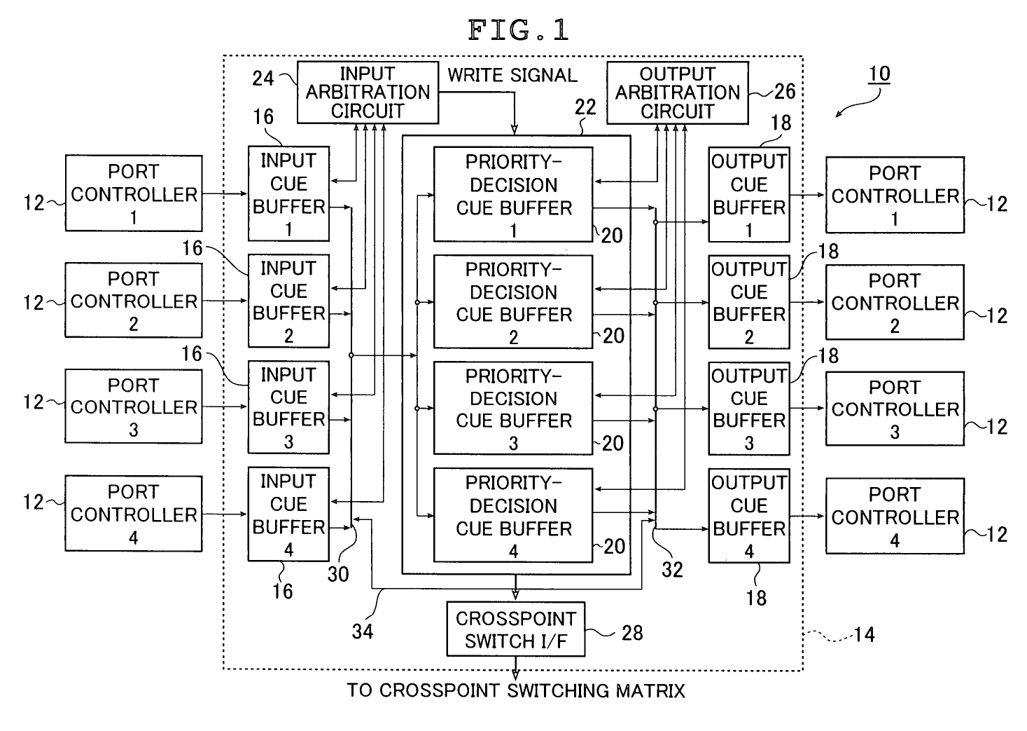

FIG. 1 is a block diagram outlining an embodiment of the network switching device according to the present invention. A network switching device 10 shown in FIG. 1 has 4 ports and performs switching control of packets having 5 levels of priority. The network switching device 10 includes port controllers 12(1) to 12(4) provided in one-to-one corresponding to each of the ports; a crosspoint switching matrix (not shown in FIG. 1; see FIG. 8); and a crosspoint switch controller 14.

Further, the crosspoint switch controller 14 includes 4 input cue buffers 16(1) to 16(4) and output cue buffers 18(1) to 18(4) which are provided in one-to-one corresponding to each of the port controllers 12; a priority decision circuit 22 comprised of 4 priority-decision cue buffers 20(1) to 20(4) similarly arranged in one-to-one correspondence with each of the port controllers 12; an input arbitration circuit 24 and an output arbitration circuit 26; and a crosspoint switch I/F (interface) 28 for controlling the crosspoint switching matrix.

Note that, in an example shown in FIG. 1, in order to make the explanation easier to understand, the input portions are arranged on the left side of the figure and the output portions are arranged on the right side of the figure. However, the port controllers 12 on the left side and the port controllers 12 on the right side do not exist separately, but are the same component.

Here, each port controller 12 is connected in a one-to-one manner to its corresponding input cue buffer 16 by an individual path. In contrast, all the input cue buffers 16 and all the priority-decision cue buffers 20 in the priority decision circuit 22 are mutually connected by a shared bus 30. Therefore, the input arbitration circuit 24 determines which input cue buffer 16 from among the 4 input cue buffers 16 will use the shared bus 30.

Further, each of the input cue buffers 16(1) to 16(4) is connected mutually with the input arbitration circuit 24. Write request signals for requesting packet transmissions are sent from the input cue buffers 16(1) to 16(4) to the input arbitration circuit 24, and response signals are sent from the input arbitration circuit 24 to the input cue buffers 16(1) to 16(4) in response to the write request signals. Also, a write signal controlling the writing of the packet is inputted from the input arbitration circuit 24 to the priority decision circuit 22.

Similarly, outputs from all of the priority-decision cue buffers 20(1) to 20(4) are connected to all of the output cue buffers 18(1) to 18(4) via a shared bus 32. Each of the priority-decision cue buffers 20(1) to 20(4) is connected mutually with the output arbitration circuit 26, and the output arbitration circuit 26 determines which priority-decision cue buffer 20 will use the shared bus 32. Further, the output cue buffers 18(1) to 18(4) and the port controllers 12(1) to 12(4) are connected to each other in a one-to-one manner.

Further, in the crosspoint switch controller 14 shown in FIG. 1, there is formed a bypass route 34 which directly connects the shared bus 30 on the input side with the shared bus 32 on the output side.

Note that, instead of using the shared buses 30 and 32, the input arbitration circuit 24, and the output arbitration circuit 26, it is also possible to construct these circuits by using selectors or the like.

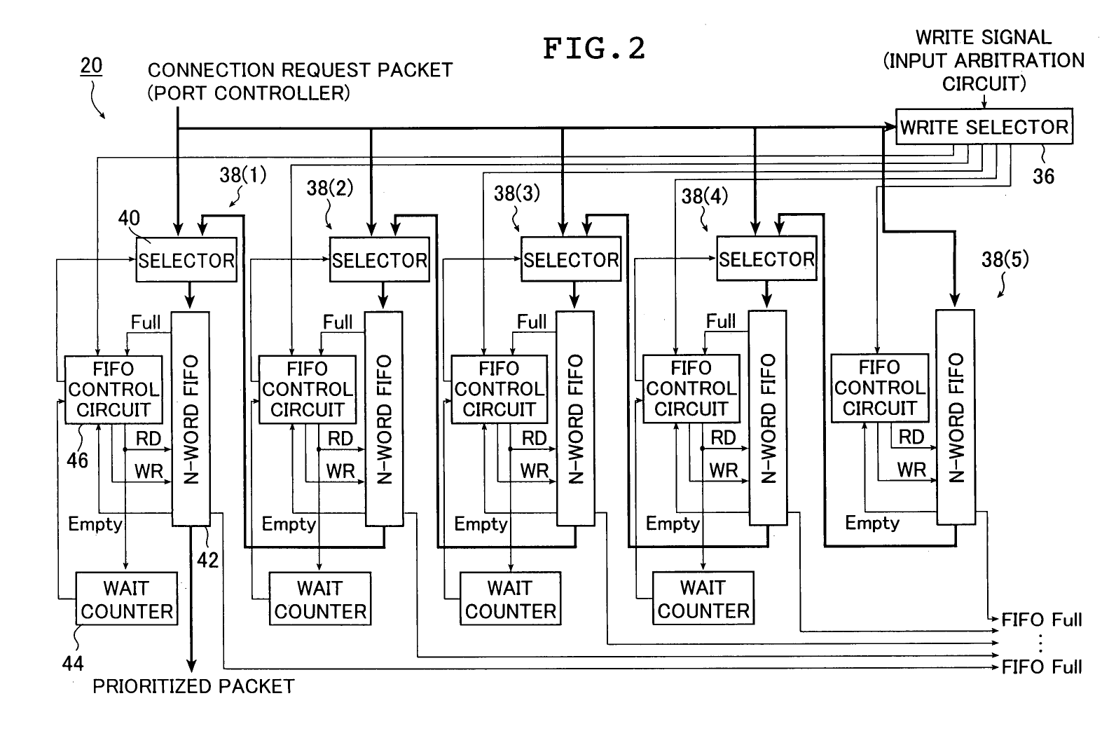

FIG. 2 is a diagram outlining a configuration of an embodiment of the priority-decision cue buffer according to the present invention.

FIG. 2 illustrates an example of the configuration of the priority-decision cue buffer 20 in a case where the packets are arbitrated according to packet priority levels and also in the order in which the packets were sent (chronological sequence). The priority-decision cue buffer 20 includes a write selector 36 and 5 priority-assignment circuits 38(1) to 38 (5) provided corresponding to each of the 5 priority levels of the packets.

Here, the write selector 36 performs control such that new connection request packets are sent to their corresponding priority-assignment circuits 38. The above-mentioned write signal from the input arbitration circuit 24 and the connection request packet from the port controller 12 are inputted into the write selector 36, and 5 write-enable-signals corresponding to each of the 5 priority levels are outputted from the write selector 36 and inputted into the priority-assignment circuits 38(1) to 38(5).

Subsequently, the priority-assignment circuits 38 hold the connection request packets in chronological sequence according to the priority levels in the packets, with the exception of an operation performed by a wait counter explained below. In the case of the example in FIG. 2, the priority-assignment circuit 38(1) on the left end of the figure is for the highest-priority packet, and the priority levels of the priority-assignment circuits 38(2) to 38(4) toward the right side are decreased one by one, such that the priority-assignment circuit 38(5) on the right end corresponds to the lowest-priority packet.

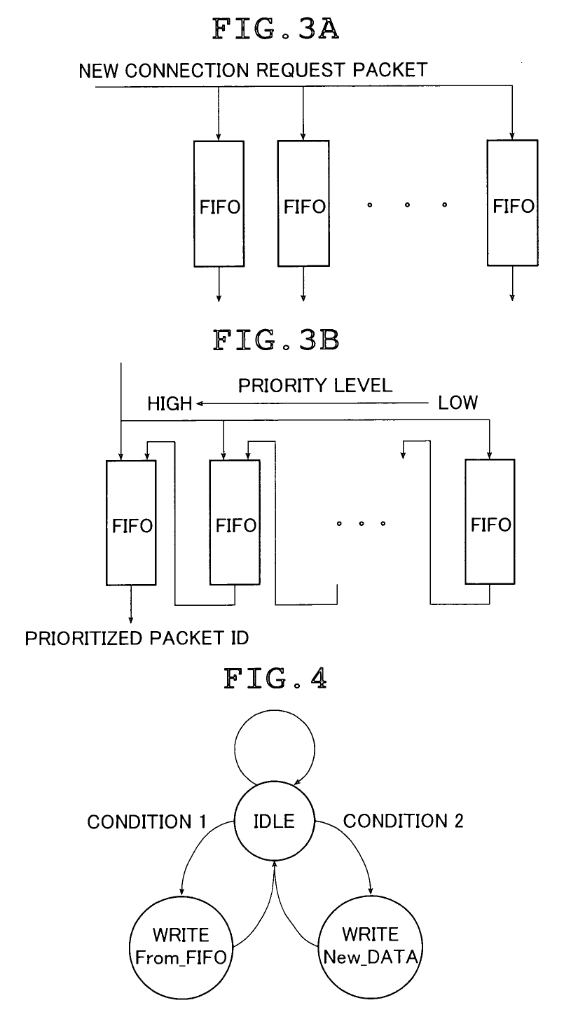

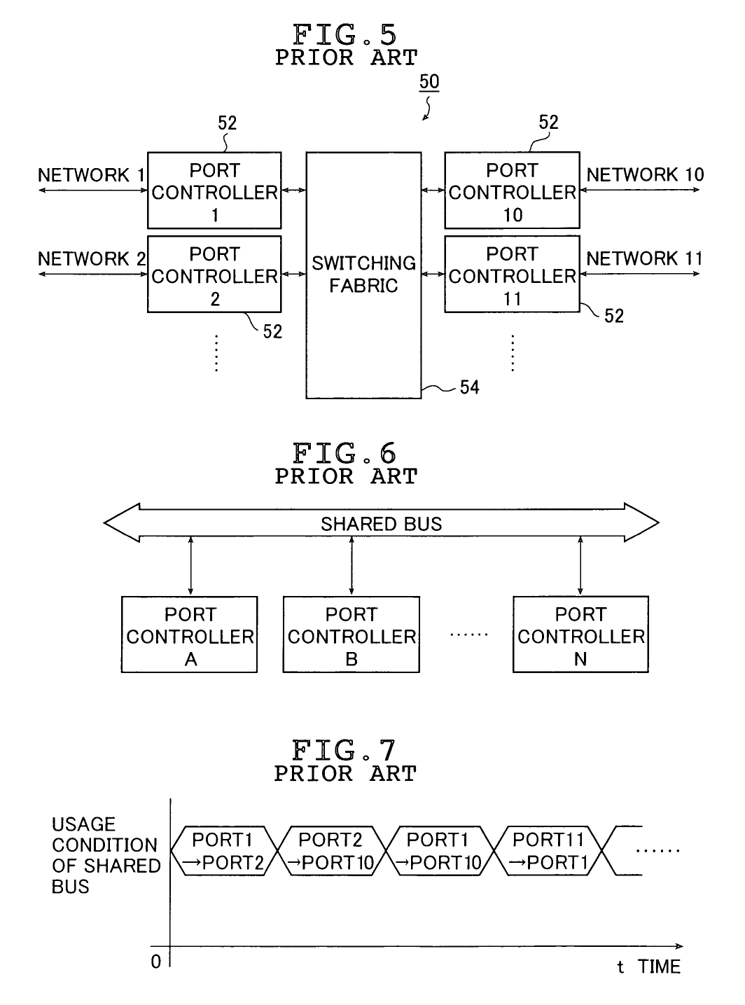

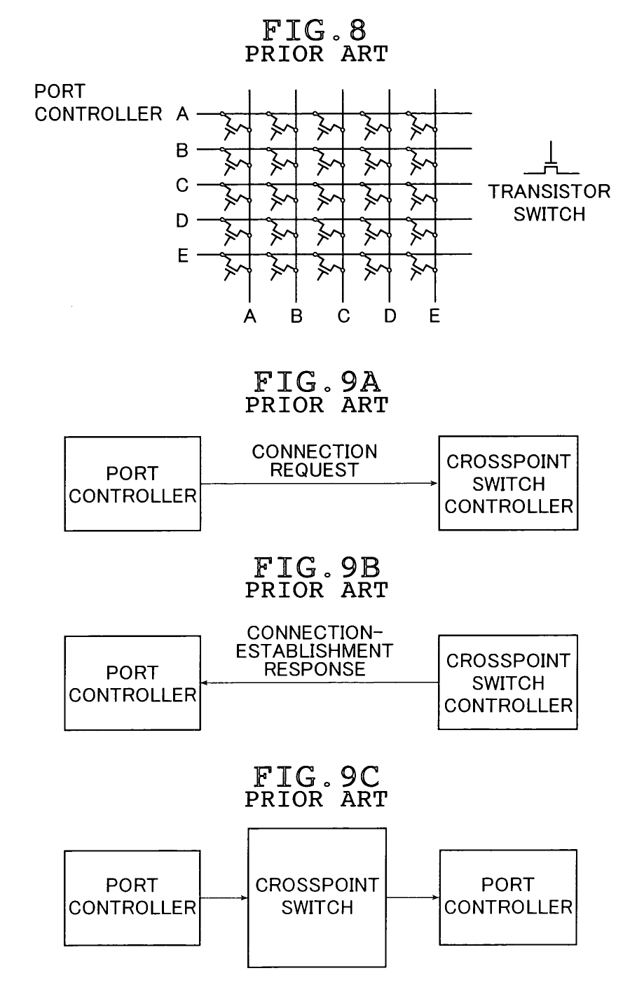

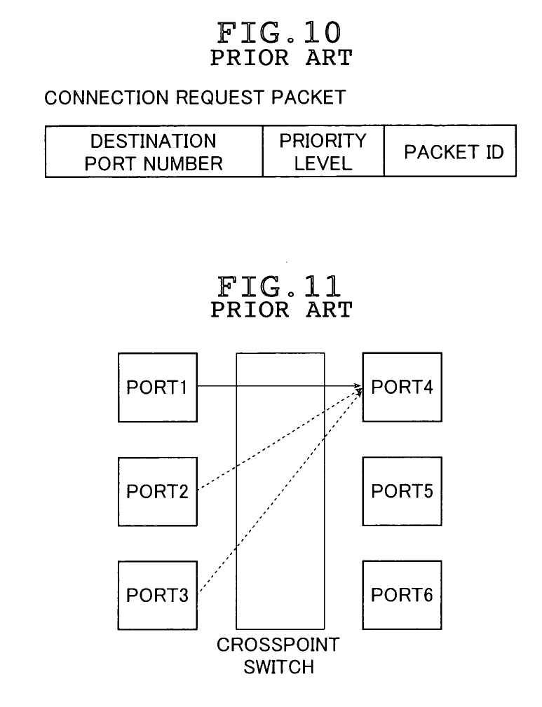

In the priority-assignment circuits 38, as shown in FIG. 3A, the new connection request packets sent from the port controllers 12 are held in chronological sequence into the FIFO buffer 42 in the priority-assignment circuits 38 according to their priority levels. Further, in a case where there is no new connection request packet, the connection request packets already being held in the priority-assignment circuits on the lower-priority side are shifted in sequence toward the priority-assignment circuits 38 on the higher-priority side, and held in it as shown in FIG. 3B.

The network switching device 10 in the example shown in FIG. 1 is provided with the priority-assignment circuits 38 for each priority level in the connection request packets, and the packets are shifted in sequence as described above. Therefore, when the new connection request packets are sent from the port controller 12, in the priority-decision cue buffers 20 in the crosspoint switch controller 14, priorities are automatically decided to the packets according to their priority levels and in chronological sequence.

Using the priority-assignment circuit 38(1) as an example to explain the priority-assignment circuits 38, each priority-assignment circuit 38 includes a selector 40; a FIFO buffer 42 with a capacity for N words; a wait counter 44; and a FIFO control circuit 46.

Here, depending on a select signal sent from the FIFO control circuit 46, the selector 40 selectively outputs a connection request packet newly sent from the port controller 12, or a connection request packet already being held in the FIFO buffer 42 of one of the priority-assignment circuits 38 on the lower-priority side (for example, the previous priority-assignment circuit 38), and sent from that FIFO buffer 42. The packet outputted from the selector 40 is sent to the FIFO buffer 42.

The FIFO buffer 42 holds the connection request packet provided from the selector 40 in chronological sequence, and has buffer cells for N (in the present embodiment, N≧4) number of words, where N is equal to or greater than the number of ports.

The packet sent from the selector 40 is written into the first buffer cell of the FIFO buffer 42 by means of the write signal WR outputted from the FIFO control circuit 46. Then, each time a subsequent packet is written, the previously written packet is shifted toward the last buffer cell side. Further, the packet being held in the last buffer cell of the FIFO buffer 42 is read out by a read signal RD provided from the FIFO control circuit 46.

Note that the packets read out from the FIFO buffers 42 of the priority-assignment circuits 38(2) to 38(5) are sent to the priority-assignment circuits 38(1) to 38(4) on the higher-priority side. Further, the packet read out from the FIFO buffer 42 in the priority-assignment circuit 38(1) corresponding to the highest priority level packets (the priority-assignment circuit on the left end in FIG. 2), is sent, as a prioritized packet, to the output cue buffer 18 that is connected to the port controller 12 of the source port.

Further, a full signal (FULL) and an empty signal (Empty) are outputted from the FIFO buffer 42. The full signal is a signal indicating that connection request packets are being stored in all the buffer cells in the FIFO buffer 42, and that the next packet will not be able to be written into the FIFO buffer 42. Further, the empty signal is a signal indicating that there is no packet being held in the FIFO buffer 42. Both of these signals are sent to the FIFO control circuit 46.

Note that, in the case of the present embodiment, the full signal is outputted also as status information (FIFO Full). This status information is used as an interrupt signal or the like for error processing.

In the case shown in FIG. 2, the wait counter 44 counts the number of packets read out from the FIFO buffer 42. The wait counter 44 counts the read signals RD which are inputted to the FIFO buffer 42 from the FIFO control circuit 46, and when the count value reaches a predetermined count value, the wait counter 44 outputs a trigger signal indicating that the count value has reached the predetermined count value. This trigger signal is sent to the FIFO control circuit 46.

Finally, the FIFO control circuit 46 controls the writing of the connection request packet into the FIFO buffer 42 and the reading of the connection request packet from the FIFO buffer 42.

As described above, the write enable signal from the write selector 36, the full signal and the empty signal from the FIFO buffer 42, and the trigger signal from the wait counter 44, are each inputted into the FIFO control circuit 46. Further, from the FIFO control circuit 46, the select signal is sent to the selector 40, and the read signal RD and the write signal WR are sent to the FIFO buffer 42, respectively.

Note that the priority-assignment circuit corresponding to the packets with the lowest priority level (the priority-assignment circuit on the right end in FIG. 2) 38(5) does not need to have the selector 40 and the wait counter 44. Therefore, in this priority-assignment circuit 38(5), the select signal is not outputted from this FIFO control circuit 46, and the trigger signal is not inputted into the FIFO control circuit 46. Further, the full signal outputted from the FIFO buffer 42 is not sent to the FIFO control circuit 46.

Incidentally, as described above, in the network switching device 10, the new connection request packet sent from the port controller 12 is held in chronological sequence in the priority-assignment circuit 38 that corresponds to the priority level in the packet, and in the case where a new connection request packet does not exist, the connection request packets already being held in the priority-assignment circuits 38 on the lower-priority side are shifted in sequence toward the priority-assignment circuits 38 on the higher-priority side.

In other words, the connection request packet newly sent from the port controller 12 is held at top priority in corresponding priority-assignment circuit 38.

However, when the new connection request packets are continuously sent to the priority-assignment circuits 38 on the higher-priority side, the connection request packets in the priority-assignment circuits 38 on the lower-priority side never have a chance to move toward the priority-assignment circuits 38 on the higher-priority side.

In order to overcome this problem, the network switching device 10 of the example in FIG. 2 is provided with the wait counter 44. The wait counter 44 counts the read signals RD inputted to the FIFO buffer 42 from the control circuit 46, and then, when the count value, that is, the number of the packets read out from the FIFO buffer 42, reaches the predetermined value, outputs the trigger signal to the FIFO control circuit 46 to notify that the predetermined number of packets have been read out from the FIFO buffer 42.

When the FIFO control circuit 46 receives the trigger signal from the wait counter 44, it operates so that the lower priority connection request packet sent from the priority-assignment circuits 38 on the lower-priority side is held in the FIFO buffer 42 at the top priority, even in the case where there is a new connection request packet. Further, the new connection request packet is held in the FIFO buffer 42 after the packet sent from the priority-assignment circuit 38 on the lower-priority side was held.

Note that the count value to be counted by the wait counter 44 may be set to any value. Further, in accordance with the present embodiment, the wait counter 44 detects that the number of the packets read out from the FIFO buffer 42 reach the predetermined number; however, the wait counter 44 is not limited to this configuration, and it may be adapted, for example, to count time and output the trigger signal when a predetermined amount of time has elapsed. In such a case, the count time to be counted by the wait counter 44 may also be set to any value.

Hereinafter, operations of the FIFO control circuit 46 will be explained with reference to state transitions shown in FIG. 4.

As illustrated in the state transition diagram in FIG. 4, when a condition 1 has been satisfied, the state of the FIFO control circuit 46 changes to a write state From_FIFO and operates so as to hold the lower priority level connection request packet sent from the priority-assignment circuit 38 on the lower-priority side. Further, when a condition 2 has been satisfied, the state of the FIFO control circuit 46 changes to a write state of New_DATA, and operates so as to hold the connection request packet that has been newly sent from the port controller 12.

Note that, in the case where there is no new connection request packet and no packet is being held in the priority-assignment circuit 38 on the lower-priority side, the state of the FIFO control circuit 46,changes to an idle state (IDLE), and thus enters a standby state.

The above-mentioned condition 1 is as follows.

Namely, the condition 1 is satisfied in the following two cases. One is the case where there is no new connection request packet and a packet is being held in the priority-assignment circuit 38 on the lower-priority side. The other is the case where there is a new connection request packet, the trigger signal is outputted from the wait counter 44, and also a packet is being held in the priority-assignment circuit 38 on the lower-priority side.

Also, the condition 2 is the case where there is a new connection request packet, and the trigger signal is not outputted from the wait counter 44.

Note that a precondition of both the condition 1 and the condition 2 is that the full signal is not being outputted from the FIFO buffer 42 in the priority-assignment circuit 38 which is going to hold the packet. When the full signal is outputted, an error occurs.

As described above, since the network switching device 10 is provided with the wait counter 44, even the packets held in the priority-assignment circuits 38 on the lower-priority side are sequenced according to appropriate timing.

Next, explanation will be made regarding the operations of the network switching device 10 illustrated in FIG. 1 and FIG. 2.

When the network switching device 10 shown in FIG. 1 performs the switching control, first, the connection request packets are sent from the port controllers 12 to the corresponding input cue buffers 16. When the input cue buffers 16 receive the connection request packets from the port controllers 12, they output the write request signals to the input arbitration circuit 24. The input arbitration circuit 24 receives the write request signals from each of the input buffers 16(1) to 16(4) and arbitrates the shared bus 30 according to a conventionally well-known method such as a round robin.

As a result, the response signal is sent from the input arbitration circuit 24 to the input cue buffer 16 which permits the use of the shared bus 30, and the input cue buffer 16 which received this response signal outputs its connection request packet on the shared bus 30. This connection request packet is sent via the shared bus 30 to the priority decision circuit 22. Further, the write signal is sent from the input arbitration circuit 24 to the priority decision circuit 22.

In the priority decision circuit 22, a decoder (not shown in FIG. 1) or the like decodes a destination port number which is included in header information in the connection request packet that has been sent from the input cue buffer 16, and the packet is sent to one of the priority-decision cue buffer 20(1) to 20(4) which corresponds to the destination port number. Similarly, the write signal from the input arbitration circuit 24 also is inputted into one of the priority-decision cue buffer 20 that corresponds to the destination port number.

As shown in FIG. 2, in the priority-decision cue buffer 20 corresponding to the destination port number, the connection request packet is sent to the write selector 36 and to the priority-assignment circuits 38(1) to 38(5), and the write signal is inputted to the write selector 36. The write selector 36 turns only one of 5 write enable signals to an “enable” state, based on the priority level contained in the header information of the connection request.

In the priority-assignment circuit 38 in which the write enable signal is in the “enable” state, the new connection request packet, or the lower priority level connection request packet sent from the priority-assignment circuit 38 on the lower-priority side is held selectively, depending on the trigger signal outputted from the wait counter 44 by the control of FIFO control circuit 46.

On the other hand, in the priority-assignment circuit 38 in which the write enable signal is not in the “enable” state, that is, in the priority-assignment circuit 38 without the new connection request packet, the lower priority level connection request packet sent from the priority-assignment circuit 38 on the lower-priority side is held.

Further, the prioritized connection request packets are read out in sequence from the FIFO buffer 42 of the priority-assignment circuit 38(1) with the highest priority level, and are sent to the crosspoint switch I/F 28 which is a control portion of the present invention, where the connection of the crosspoint switch (not shown in FIG. 1) is controlled in accordance with the content of the packet. Then, sending and receiving of packets of data are performed between the source port and the destination port via the crosspoint switch in which the connection is established.

Note that, in the above-mentioned embodiment, the number of the ports is configured as 4 ports, and the priority levels in the connection request packets are 5 levels; however, the present invention is not restricted to this, and any number of ports and any priority levels may be used.

Further, any of the conventional well-known circuit structures may be used for the circuit structures of the port controllers 12, the input cue buffers 16, the input arbitration circuit 24 and the output arbitration circuit 26, the crosspoint switch I/F 28, the crosspoint switch, and the like. Further, there are no particular restrictions as to the circuit structures of the write selector 36, the selector 40, the FIFO buffer 42, the FIFO control circuit 46, the wait counter 44 and the like, which constitute the priority-decision cue buffers in the priority decision circuit that is a characterizing portion of the present invention. Any type of circuit structure which achieves similar functions may be used.

The network switching device of the present invention is basically as described above.

The network switching device of the present invention is described in detail above; however, the present invention is not restricted to the above-mentioned embodiment, and it goes without saying that various improvements and modifications may be made without departing from the essence of the present invention.

### INDUSTRIAL APPLICABILITY

As described above in detail, in the network switching device according to the present invention, the new connection request packets are held in chronological sequence in the priority-assignment circuits provided corresponding to the priority levels of the connection request packets, and in the case where no new connection request packet exists, the connection request packets being held in the-priority-assignment circuits of the lower-priority side are shifted in sequence toward the priority-assignment circuits on the higher-priority side, to be held there.

As a result, in accordance with the network switching device of the present invention, when the new connection request packets are sent from the port controllers, they are automatically ordered according to their priority levels and in chronological sequence by the priority-decision cue buffers in the crosspoint switch controller, so that the arbitration of the connection requests can be performed efficiently.

What is claimed is:

1. A network switching device having a plurality of ports, for performing switching control between source ports and destination ports to transmit packets among the plurality of the ports, comprising:
a plurality of port controllers provided in one-to-one corresponding to each of the ports; a switching fabric for connecting the source ports and the destination ports; and a switching fabric controller for controlling the plurality of the port controllers and the switching fabric according to priority levels assigned to the packets to be transmitted,
wherein, the switching fabric controller comprises a priority decision circuit for holding connection request packets sent from each of the port controllers and deciding the priorities of the connection request packets according to the priority levels contained in the connection request packets; and a control portion for controlling the switching fabric according to the priority level of the connection request packet.

2. A network switching device according to claim 1, the priority decision circuit comprises a plurality of priority-decision cue buffers provided in one-to-one corresponding to each of the ports for deciding the priority of the connection request packet transmitted to each corresponding port according to the priority level in the connection request packet;
each of the priority-decision cue buffers comprises a plurality of priority-assignment circuits provided corresponding to each of the priority levels in the connection request packet for holding the connection request packet in chronological sequence according to the priority level in the connection request packet; and a write selector for performing control such that a new connection request packet sent from the port controllers is sent to the priority-assignment circuit corresponding to the priority level in the new connection request packet; and
the new connection request packet is held in chronological sequence in the priority-assignment circuit corresponding to the priority level in the new connection request packet, and in a case where the new connection request packet does not exist, the connection request packets being held in the priority-assignment circuits on the lower-priority side are shifted in sequence toward the priority-assignment circuits on the higher-priority side, to be held there.

3. A network switching device according to claim 2, the priority-assignment circuit comprises:
a selector for selectively outputting the new connection request packet, or a lower priority level connection request packet being held in the priority-assignment circuit on the lower-priority side;
a FIFO buffer having buffer cells equal to or more than the ports in number, for holding, in chronological sequence, the connection request packets sent from the selector;
a wait counter for counting the number of the connection request packets read out from the FIFO buffer, or for counting time, and for outputting a trigger signal when a counted value reaches a predetermined value; and
a FIFO control circuit for controlling writing of the connection request packet into the FIFO buffer and reading of the connection request packet from the FIFO buffer.

4. A network switching device according to claim 3, the FIFO buffer outputs a full signal indicating that the connection request packets have been held into all the buffer cells in the FIFO buffer and that a subsequent packet cannot be written thereinto, and an empty signal indicating that no packets are being held in the FIFO buffer, and these signals are sent to the FIFO control circuit, and moreover the full signal is outputted also as status information for error processing.

5. A network switching device according to claim 3 or 4, when the FIFO control circuit receives the trigger signal from the wait counter, the FIFO control circuit operates such that the lower priority level connection request packet sent from the priority-assignment circuit on the lower priority level side is held with top priority, even in the case where there is the new connection request packet.

6. A network switching device according to any one of claims 2 to 5, the switching fabric controller further comprises a plurality of input cue buffers provided in one-to-one corresponding to each of the port controllers, for holding the packet inputted from each corresponding port.

7. A network switching device according to claim 6,
each of the port controllers and each of the corresponding input cue buffers are connected to each other in a one-to-one manner by separate individual paths, and all the input cue buffers and all the priority-decision cue buffers in the priority decision circuit are mutually connected via a first shared bus; and
the network switching device further comprises an input arbitration circuit for determining which input cue buffer from among the plurality of the input cue buffers uses the first shared bus.

8. A network switching device according to any one of claims 2 to 7, the switching fabric controller further comprises a plurality of output cue buffers provided in one to one corresponding to each of the port controllers, for holding the packet outputted to each corresponding port.

9. A network switching device according to claim 8,
each of the port controllers and each of the corresponding-output cue buffers are connected to each other in a one to one manner by separate individual paths, and all the output cue buffers and all the priority-decision cue buffers in the priority decision circuit are mutually connected via a second shared bus; and
the network switching device further comprises an output arbitration circuit for determining which output cue buffer from among the plurality of the output cue buffers uses the second shared bus.

10. A network switching device according to claim 9, a bypass route directly connecting the first shared bus and a second shared bus is formed.

11. A network switching device according to any one of claims 1 to 10, the switching fabric is a crosspoint switching matrix.

12. A priority-assignment circuit for holding connection request packets sent from the plurality of ports according to priority levels assigned to the connection request packets in chronological sequence, when switching control of source ports and destination ports is performed to transmit packets among a plurality of ports, comprising:
a selector for selectively outputting a new connection request packet sent from each of the ports, or a lower priority level connection request packet being held in the priority-assignment circuit on the lower-priority side;
a FIFO buffer having a plurality of buffer cells, for holding, in chronological sequence, the connection request packets sent from the selector;
a wait counter for counting the number of the connection request packets read out from the FIFO buffer, or for counting time, and for outputting a trigger signal when a counted value reaches a predetermined value; and
a FIFO control circuit for controlling writing of the connection request packet into the FIFO buffer and reading of the connection request packet from the FIFO buffer.

13. A priority-assignment circuit according to claim 12, the FIFO buffer outputs a full signal indicating that the connection request packets have been held into all the buffer cells in the FIFO buffer and that a subsequent packet cannot be written thereinto, and an empty signal indicating that no packets are being held in the FIFO buffer, and these signals are sent to the FIFO control circuit, and moreover the full signal is outputted also as status information for error processing.

14. A priority-assigned circuit according to claim 12 or 13, when the FIFO control circuit receives the trigger signal from the wait counter, the FIFO control circuit operates such that the lower priority level connection request packet sent from the priority-assignment circuit on the lower priority level side is held into the FIFO buffer with top priority, even in the case where there is the new connection request packet.

15. A priority-decision cue buffer for deciding priorities of connection request packets to be sent to each destination port according to priority levels in the connection request packets sent from the plurality of ports, when switching control between source ports and destination ports is performed to transmit packets among a plurality of ports, comprising:
a plurality of the priority-assignment circuits as set forth in any one of claims 12 to 14 provided corresponding to each of the priority levels in the connection request packets; and a write selector for performing control such that a new connection request packet sent from each of the ports is sent to the priority-assignment circuit of the corresponding priority level; and
the new connection request packet is held in chronological sequence in the priority-assignment circuit corresponding to the priority level in the new connection request packet, and in a case where no new connection request packet exists, the connection request packets being held in the priority-assignment circuits on the lower-priority side are shifted in sequence toward the priority-assignment circuits on the higher-priority side, to be held there.

16. A priority decision circuit for holding connection request packets sent from the plurality of ports and deciding priorities of the connection request packets according to the priority levels in the connection request packets,
when switching control of source ports and destination ports is performed to transmit packets among a plurality of ports, comprising: a plurality of priority-decision cue buffers as set forth in claim 15.

17. A switching fabric controller for controlling a switching fabric for connecting the source ports with the destination ports, when switching control of source ports and destination ports is performed to transmit packets among a plurality of ports, comprising:
a priority decision circuit as set forth in claim 16; and a control portion for controlling the switching fabric according to the priority levels in the connection request packets.

18. A switching fabric controller according to claim 17, further comprising: a plurality of input cue buffers provided in one to one corresponding to each of the port controllers that are provided in one to one corresponding to each of the ports, for holding the packet inputted from each corresponding port.

19. A switching fabric controller according to claim 18,
each of the port controllers and each of the corresponding input cue buffers are connected to each other in one to one manner by separate individual paths, and all the input buffers and all the priority-decision cue buffers in the priority decision circuit are mutually connected via a first shared bus; and
the switching fabric controller comprises an input arbitration circuit for determining which input cue buffer from among the plurality of the input cue buffers uses the first shared bus.

20. A switching fabric controller according to any one of claims 17 to 19, further comprising: a plurality of output cue buffers provided in one to one corresponding to each of the port controllers and holding packet outputted
